(19) United States
(12) Patent Application Publication
(10) Pub. No.: US 2018/0268378 A1
(43) Pub. Date: Sep. 20, 2018

(54) SYSTEM AND METHOD FOR EVALUATING FUNCTIONALITY OF MOBILE PHONES

(71) Applicants: HONGFUJIN PRECISION ELECTRONICS (ZHENGZHOU) CO., LTD., Zhengzhou (CN); HON HAI PRECISION INDUSTRY CO., LTD., New Taipei (TW)

(72) Inventors: EDDY LIU, New Taipei (TW); YU-NAN LIN, New Taipei (TW); WEI-DA YANG, New Taipei (TW); PO-LIN SU, New Taipei (TW); GUO-WEI LIU, Zhengzhou (CN); QING WANG, Zhengzhou (CN); JIE-PENG KANG, Zhengzhou (CN); XIAO-JUN JIANG, Zhengzhou (CN)

(21) Appl. No.: 15/697,361

(22) Filed: Sep. 6, 2017

(30) Foreign Application Priority Data
Mar. 17, 2017 (CN) 201710158605.7

(51) Int. Cl. G06Q 10/00; H04M 1/24; G06Q 30/02

(52) U.S. Cl. CPC G06Q 10/30; H04M 1/24; Y02W 90/20; Y02W 30/82; G06Q 30/0278

(57) ABSTRACT

A system for evaluating all functions of a mobile phone to benefit recycling purposes includes a robotic arm assembly, a camera test device, a touch test device, and a 3D Touch test device. The camera test device has a backlight screen and a target picture. The touch test device has at least one first stylus for applying input to a touch screen of a mobile phone. The 3D Touch test device has at least one second stylus for applying strong presses to the touch screen of the mobile phone. The robotic arm assembly can also move the mobile phone to enable image-capturing. A method for functionality-testing is also provided.

### CROSS REFERENCE TO RELATED APPLICATION

This application claims priority to Chinese Patent Application No. 201710158605.7, filed Mar. 17, 2017, the disclosure of which is incorporated herein by reference in its entirety.

### FIELD

The present disclosure relates to recycling mobile phones, and more particularly to a system and method for evaluating mobile phones, which is beneficial to recycling mobile phones.

### BACKGROUND

Mobile phones are becoming increasingly popular, while mobile phone replacement cycle is shortened. Therefore, the number of used mobile phones is increasing. However, the recovery of the used mobile phones is very low such that most of the used mobile phones become electronic waste when discarded. Electronic and all other types of waste have an impact not only on the environment but also on people's health.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic perspective view of a system for evaluating mobile phones.

FIG. 2 is a schematic partial perspective view of the system of FIG. 1.

FIG. 3 is a schematic perspective view of an access device of the system of FIG. 1.

FIG. 4 is a schematic perspective view of a camera test device of the system of FIG. 1.

FIG. 5 is a schematic perspective view of a robotic arm assembly of the system of FIG. 1.

FIG. 6 is a schematic perspective view of a touch test device of the system of FIG. 1.

FIG. 7 is a schematic perspective view of a 3D Touch test device of the system of FIG. 1.

FIG. 8 is a schematic bottom view of a lighting device of the system of FIG. 1.

FIG. 9 is a block diagram of the system of FIG. 1.

FIGS. 10 and 11 are a flow diagram of a method for evaluating mobile phones.

FIG. 12 is a flow diagram of substep of step 103 of the method of FIG. 10.

FIG. 13 is a flow diagram of substeps of step 107 of the method of FIG. 10.

FIG. 14 is a flow diagram of substeps of step 111 of the method of FIG. 11.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

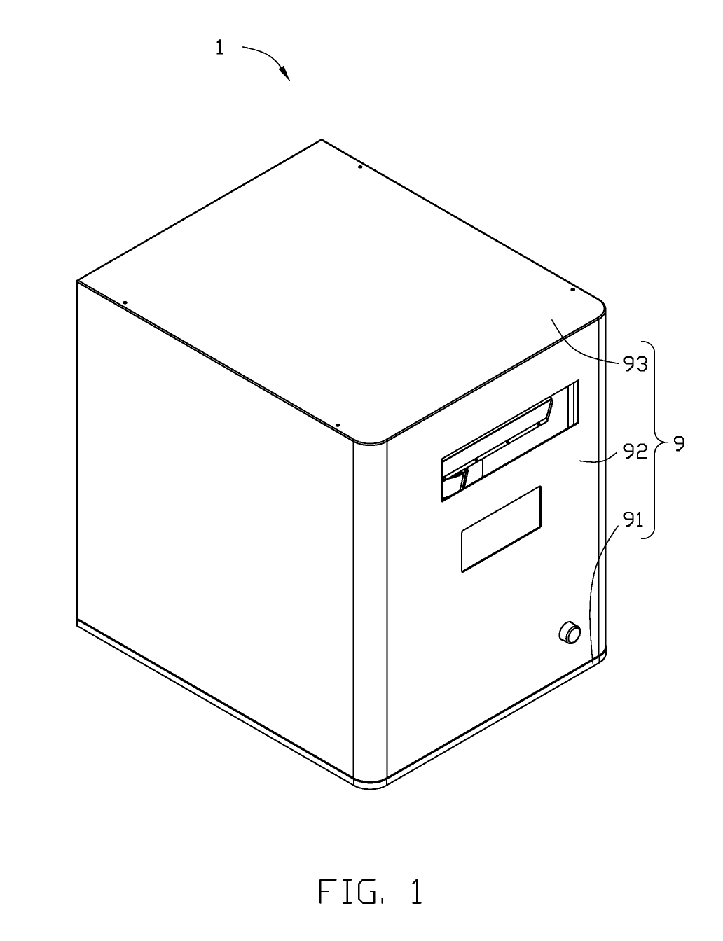

With reference to FIGS. 1-4, an exemplary embodiment of a system 1 for evaluating mobile phones includes a housing 9, an access device 2, a robotic arm assembly 4, a camera test device 3, a touch test device 5, a 3D Touch test device 6, and a lighting device 7.

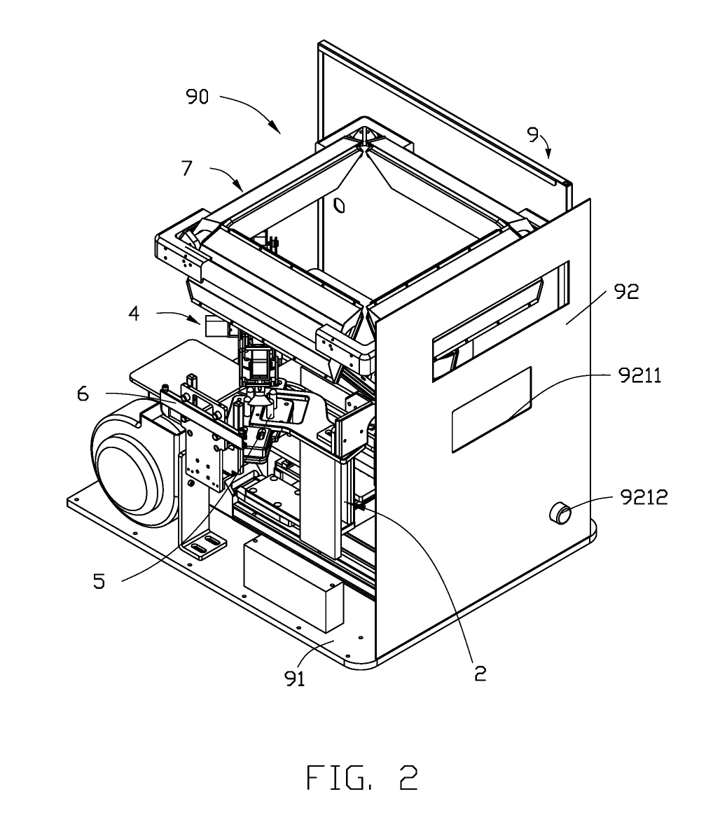

With reference to FIGS. 1 and 2, the housing 9 has a bottom wall 91, a top wall 93, a side wall 92, a chamber 90, and a button 9212. The side wall 92 connects the top wall 93 and the bottom wall 91. The side wall 92 has an opening 9211 for putting in and taking out a mobile phone 100. The chamber 90 is enclosed by the bottom wall 91, the side wall 92, and the top wall 93. The chamber 90 receives the access device 2, the camera test device 3, the robotic arm assembly 4, the touch test device 5, the 3D Touch test device 6, and the lighting device 7. The button 9212 is mounted to the side wall 92, and is used to turn the system 1 on and off.

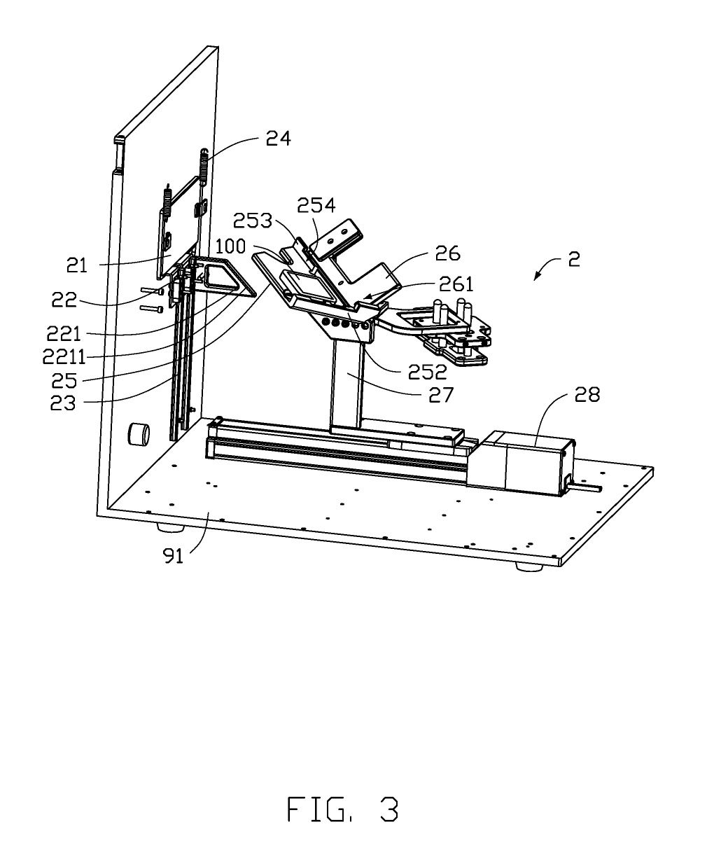

With reference to FIGS. 2 and 3, the access device 2 has a track 23, a slider 22, a shutter 21, a pressing member 221, at least one first elastic member 24, an electric cylinder 28, a first support stand 27, a first carrier 25, a second carrier 26, a first side panel 252, a second side panel 253, a first space 254, and a second space 261. The track 23 is secured to an inner surface of the side wall 92 of the housing 9 adjacent to the opening 9211. The slider 22 is movable along the track 23. The shutter 21 is secured to the slider 22, and is moved with the slider 22 to selectively open and close the opening 9211 of the side wall 92 of the housing 9. The pressing member 221 is attached to the shutter 21, and has an inclined surface 2211. The at least one first elastic member 24 has opposite ends, one of which is attached to the inner surface of the side wall 92 of the housing 9, and the other one of which is attached to the shutter 21.

The electric cylinder 28 is mounted on an inner surface of the bottom wall 91 of the housing 9. The first support stand 27 is moved by the electric cylinder 28. The first carrier 25 is attached to the first support stand 27, and is moved with the first support stand 27 to selectively press the inclined surface 2211 of the pressing member 221. The second carrier 26 is connected to the first carrier 25. The first side panel 252 and the second side panel 253 extend from the first carrier 25. The first space 254 is bounded by the first carrier 25, the first side panel 252, and the second side panel 253. The second space 261 is bounded by the second carrier 26, the first side panel 252, and the second side panel 253. The first and second spaces 254 and 261 can hold the mobile phone 100.

In an initial condition, the first carrier 25 is adjacent to the side wall 92 of the housing 9. The first carrier 25 does not press the pressing member 221, and the first elastic member 24 provides a restoring force to the shutter 21 to close the opening 9211 of the side wall 92. When the electric cylinder 28 drives the first carrier 25 to begin to move away from the side wall 92 of the housing 9, the first carrier 25 presses the pressing member 221 such that the slider 22 is moved downwardly along the track 23, so as to move the shutter 21 to open the opening 9211 of the side wall 92, and so as to stretch the first elastic member 24. When the electric cylinder 28 continues to drive the first carrier 25 away from the side wall 92 of the housing 9, the first carrier 25 is separated from the pressing member 221 such that the first elastic member 24 provides the restoring force to the shutter 21 to close the opening 9211 of the side wall 92.

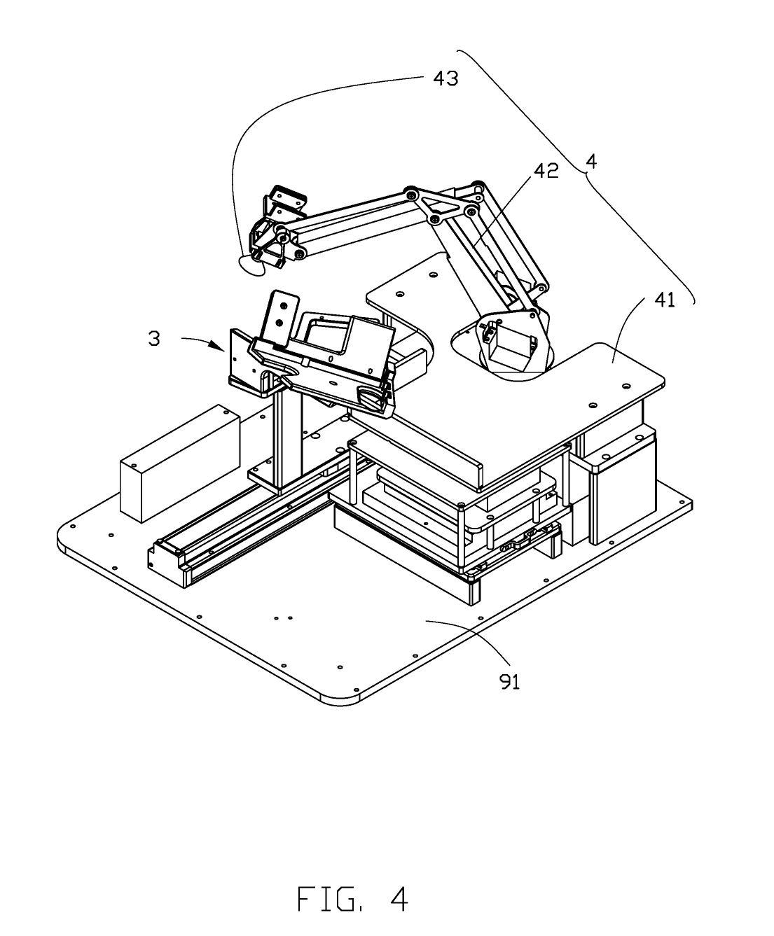

With reference to FIG. 4, the robotic arm assembly 4 can move the mobile phone 100. The robotic arm assembly 4 has a support base 41, a robotic arm 42, and a vacuum suction nozzle 43. The support base 41 is secured to the inner surface of the bottom wall 91 of the housing 9. The robotic arm 42 is rotatably mounted on the support base 41. The vacuum suction nozzle 43 is mounted on the robotic arm 42. The vacuum suction nozzle 43 can grip the mobile phone 100, to enable the mobile phone 100 to be moved to a target position by a movement of the robotic arm 42.

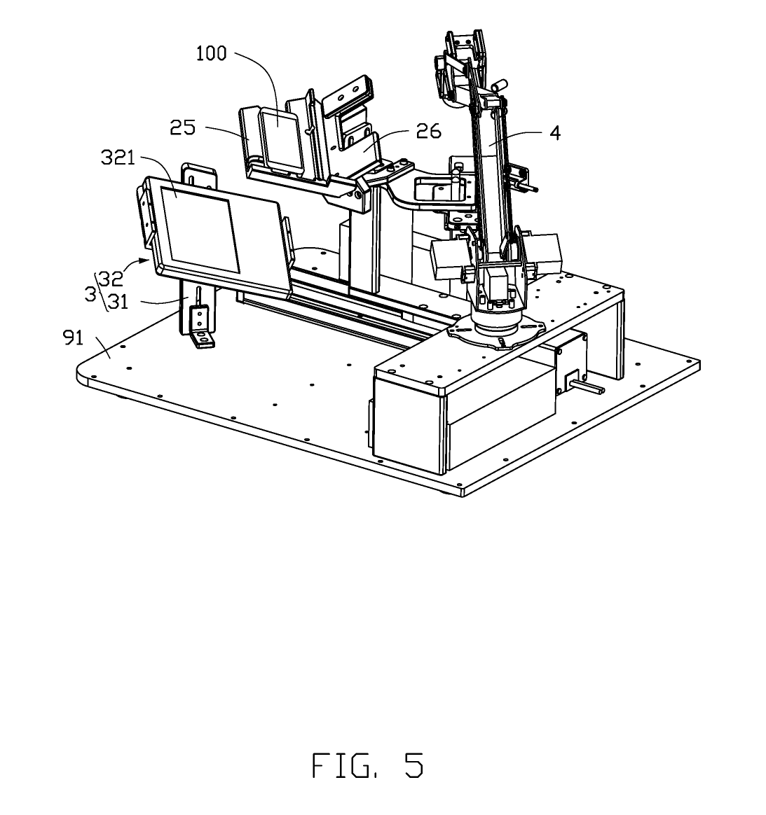

With reference to FIG. 5, the camera test device 3 has a second support stand 31, a backlight screen 32, and a target picture 321. The second support stand 31 is secured to the inner surface of the bottom wall 91 of the housing 9. The backlight screen 32 is attached to the second support stand 31. The target picture 321 is attached to the backlight screen 32. The backlight screen 32 can provide light such that a front camera and a rear camera of the mobile phone 100 can take pictures of the target picture 321 in a clear and detailed form.

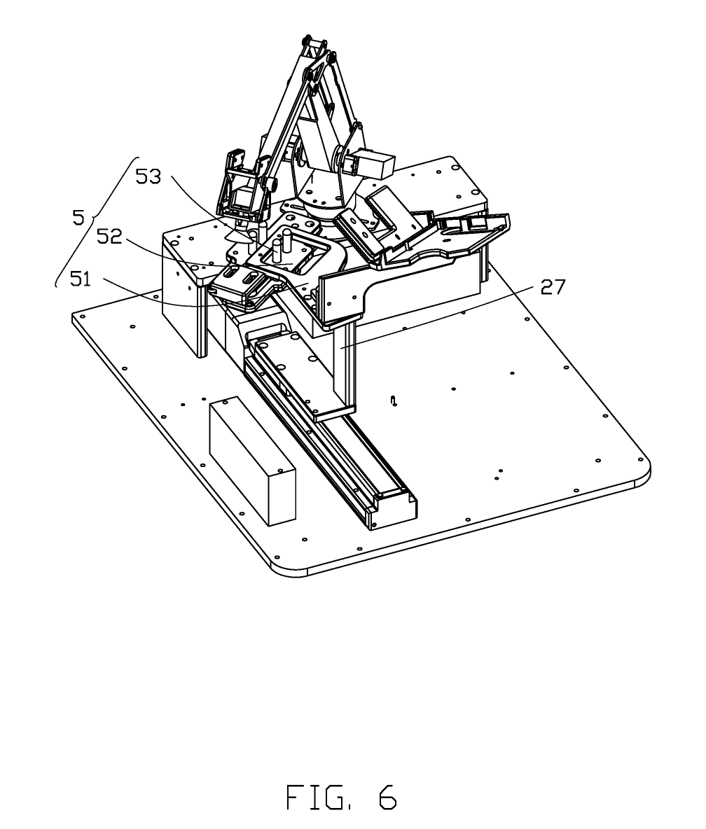

With reference to FIG. 6, the touch test device 5 has a connection panel 51, a mounting panel 52, and at least one first stylus 53. The connection panel 51 is attached to the first support stand 27. The mounting panel 52 is attached to the connection panel 51. The at least one first stylus 53 is mounted on the mounting panel 52 for touching a touch screen of the mobile phone 100.

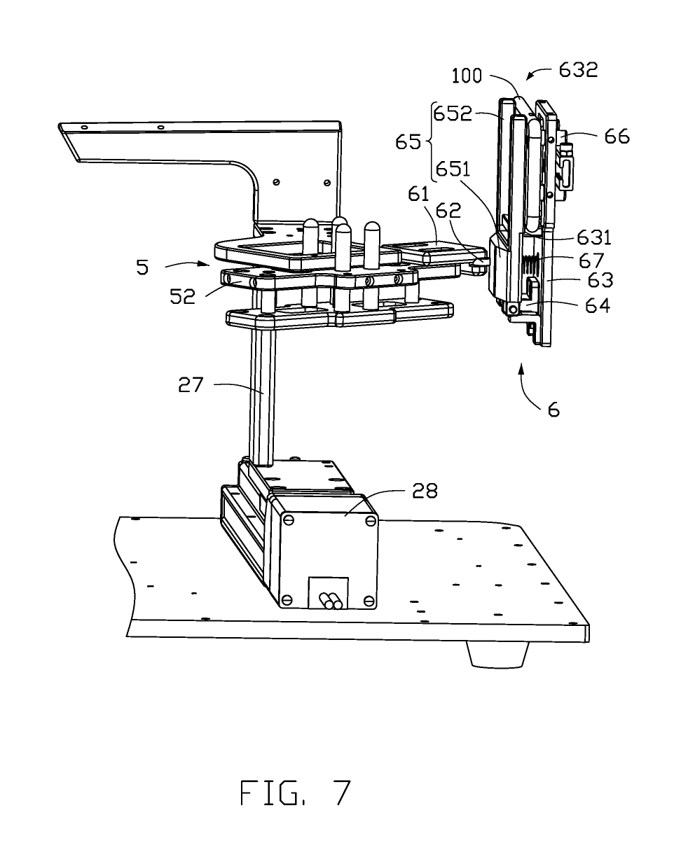

With reference to FIG. 7, the 3D Touch test device 6 has a fixed panel 63, at least one second stylus 66, a third carrier 631, a support block 64, an abutting member 65, a second elastic member 67, a third space 632, a mounting block 61, and a roller 62. The fixed panel 63 is secured to the inner surface of the side wall 92 of the housing 9. The at least one second stylus 66 is mounted on the fixed panel 63 for applying input presses to the touch screen of the mobile phone 100. The third carrier 631 is attached to the fixed panel 63. The support block 64 is attached to the fixed panel 63. The abutting member 65 has a trapezoidal shaped body 651 and two arms 652. The body 651 is pivotally mounted to the support block 64. The two arms 652 extend from opposite sides of the body 651. The second elastic member 67 is connected between the fixed panel 63 and the body 651 of the abutting member 65. The second elastic member 67 has opposite ends, one of which is attached to the fixed panel 63, and the other one of which is attached to the body 651 of the abutting member 65. The third space 632 is defined among the fixed panel 63, the third carrier 631, and the arms 652 of the abutting member 65. The third space 632 can receive and hold the mobile phone 100. The mounting block 61 is attached to the mounting panel 52 of the touch test device 5. The roller 62 is rotatably mounted to the mounting block 61, and abuts the body 651 of the abutting member 65. The roller 62 rotates and moves on the body 651 of the abutting member 65 when the first support stand 27 is moved by the electric cylinder 28.

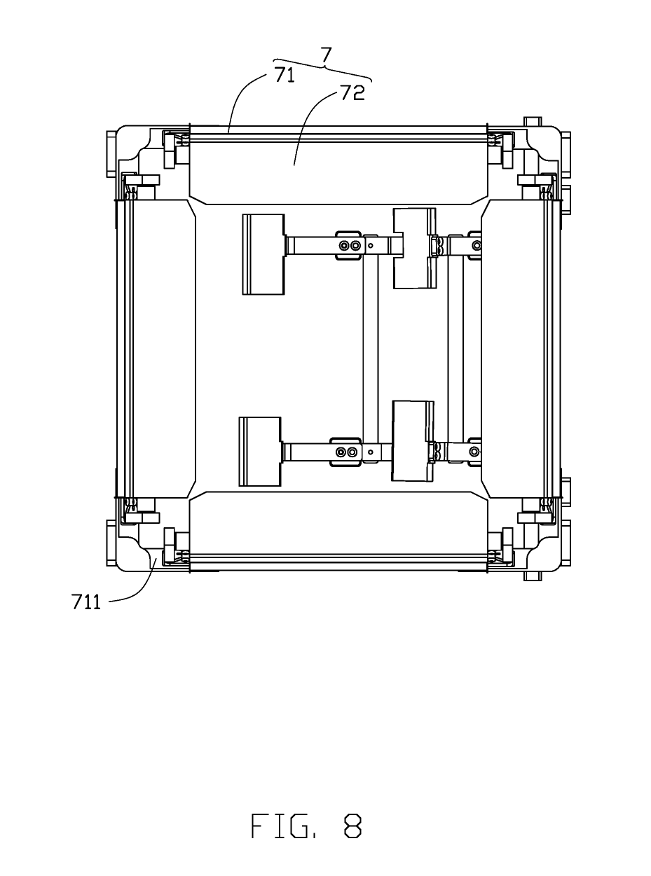

With reference to FIG. 8, the lighting device 7 has a bracket 71 and a plurality of incandescent shadowless lamps 72 mounted on the bracket 71. The incandescent shadowless lamps 72 can provide light for taking pictures. In the present exemplary embodiment, the lighting device 7 has a square bracket 71 and four incandescent shadowless lamps 72. The bracket 71 has four side portions, and the four incandescent shadowless lamps 72 are mounted on the four side portions of the bracket 71.

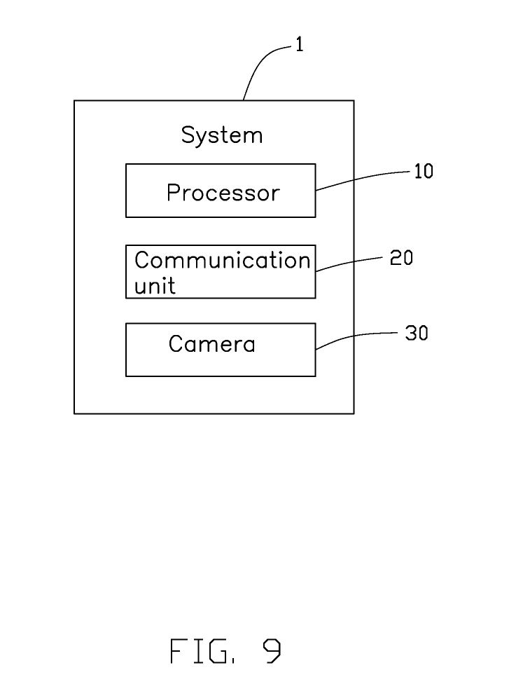

With reference to FIG. 9, the system 1 for evaluating mobile phones further includes a processor 10, a communication unit 20, and a camera 30. The processor 10 can control the electric cylinder 28 to drive the shutter 21 to open the opening 9211 of the side wall 92 for putting the mobile phone 100 in the first space 254, and can control the vacuum suction nozzle 43 to grip the mobile phone 100 and then control the robotic arm 42 to move the mobile phone 100 to a first position adjacent to the backlight screen 32, to enable the front camera and the rear camera of the mobile phone 100 to take pictures of the target picture 321. The processor 10 can receive a first image taken by the front camera and a second image taken by the rear camera. The processor 10 can control the robotic arm 42 to move the mobile phone 100 to a second position adjacent to the first stylus 53, and can then control the first stylus 53 to touch the touch screen of the mobile phone 100 to perform a touch input test. The processor 10 can receive touch test data from the touch test, and can control the robotic arm 42 to move the mobile phone 100 to a third position adjacent to the second stylus 66, and can then control the second stylus 66 to press the touch screen of the mobile phone 100 to perform a 3D Touch test. The processor 10 can receive 3D Touch test data from the 3D Touch test, and can control the robotic arm 42 to move the mobile phone 100 to a fourth position under the lighting device 7. The camera 30 can be controlled to take six images of the visible appearance of the mobile phone 100. The processor 10 can receive data as to appearance images of the mobile phone 100. The processor 10 can generate an evaluation report for the mobile phone 100 based on the first image, the second image, the touch test data, the 3D Touch test data, and the data as to appearance. The processor 10 may be a central processing unit (CPU), a microprocessor, a server, or other processing unit. The communication unit 20 communicates with the mobile phone 100. The communication unit 20 may be a WiFi unit.

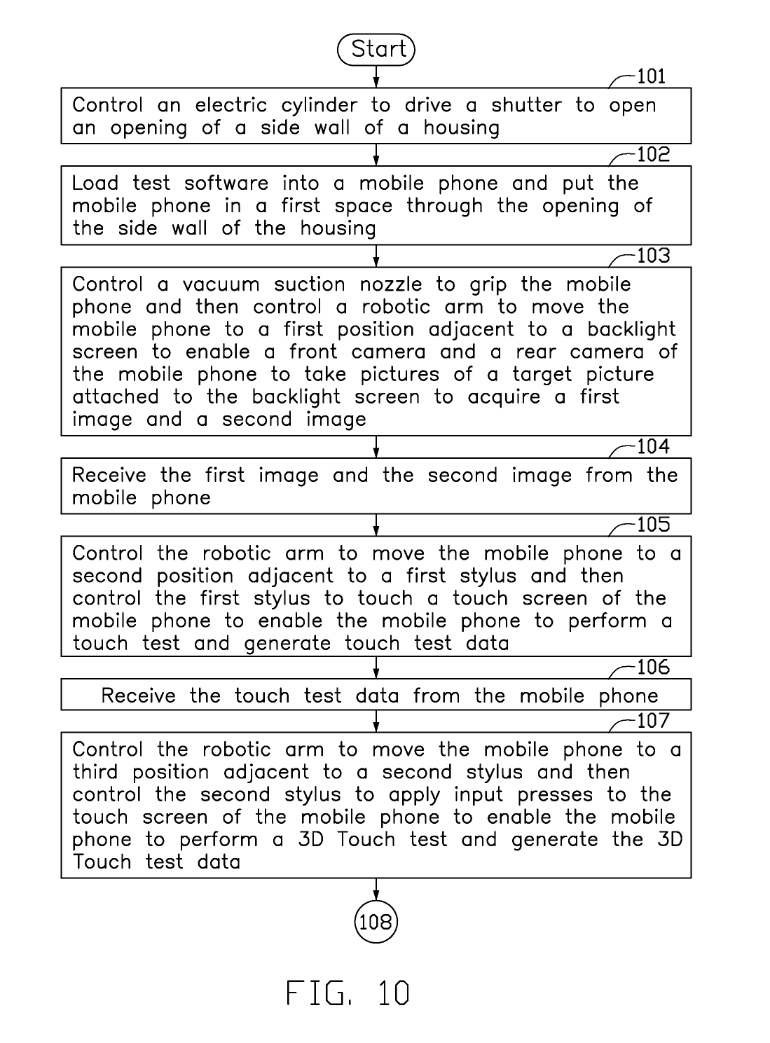

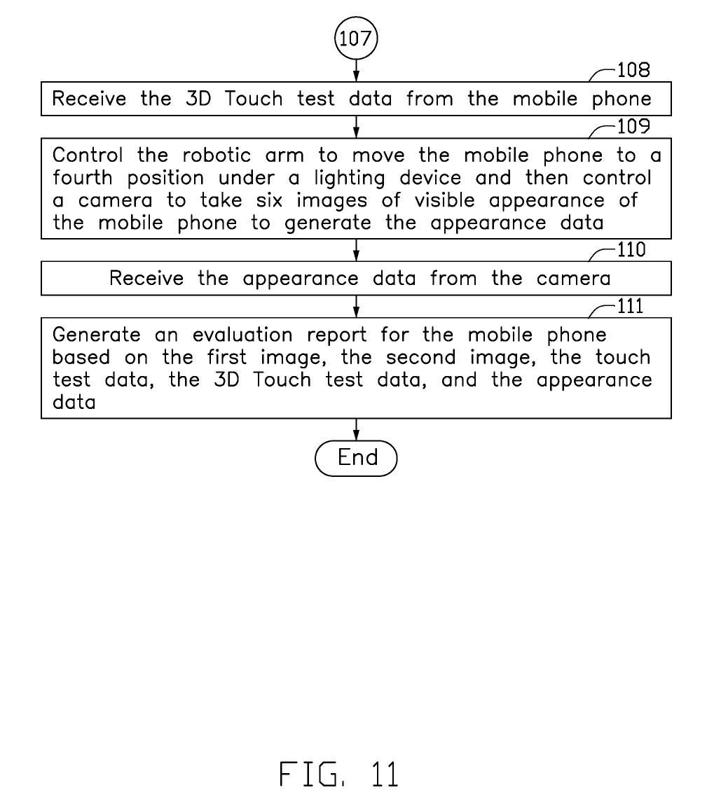

With reference to FIGS. 10 and 11, an exemplary embodiment of a method for evaluating mobile phones is illustrated.

In step 101, the processor 10 controls the electric cylinder 28 to drive the shutter 21 to open the opening 9211 of the side wall 92 of the housing 9. In detail, the processor 10 controls the electric cylinder 28 to drive the first carrier 25 to begin to move away from the side wall 92 of the housing 9 such that the first carrier 25 presses the pressing member 221 and the slider 22 is moved downwardly along the track 23 so as to move the shutter 21 to open the opening 9211 of the side wall 92 and so as to stretch the first elastic member 24.

In step 102, test software is loaded into the mobile phone 100 and the mobile phone 100 is put in the first space 254 through the opening 9211 of the side wall 92 of the housing 9. In detail, the test software is program code for testing functions of the mobile phone 100, and the test software includes camera test software, touch test software, and 3D Touch test software, and the camera test software is used to test the front camera and the rear camera of the mobile phone 100, the touch test software is used to test the touch function of the mobile phone 100, and the 3D Touch test software is used to test the 3D Touch function of the mobile phone 100. In other exemplary embodiments, the test software further includes GPS test software, WiFi test software, compass test software, accelerometer test software, speaker test software, microphone test software, vibration motor test software, distance sensor test software, Bluetooth test software, and headset test software, and the GPS test software is used to test GPS of the mobile phone 100, the WiFi test software is used to test WiFi of the mobile phone 100, the compass test software is used to test a compass of the mobile phone 100, the accelerometer test software is used to test an accelerometer of the mobile phone 100, the speaker test software is used to test a speaker of the mobile phone 100, the microphone test software is used to test a microphone of the mobile phone 100, the vibration motor test software is used to test a vibration motor function of the mobile phone 100, the distance sensor test software is used to test a distance sensor of the mobile phone 100, and the Bluetooth test software is used to test Bluetooth of the mobile phone 100, and the headset test software is used to test a headset of the mobile phone 100, and the above test software is conventional and thus is not described in detail.

In step 103, the processor 10 controls the vacuum suction nozzle 43 to grip the mobile phone 100 and then controls the robotic arm 42 to move the mobile phone 100 to the first position adjacent to the backlight screen 32 to enable the front camera and the rear camera of the mobile phone 100 to take pictures of the target picture 321 attached to the backlight screen 32. In detail, the camera test software in the mobile phone 100 is executed by the processor 10 to control the front camera and the rear camera of the mobile phone 100 to take pictures of the target picture 321 and then transmits the first image taken by the front camera and the second image taken by the rear camera to the system 1.

In step 104, the processor 10 receives the first image and the second image from the mobile phone 100.

In step 105, the processor 10 controls the robotic arm 42 to move the mobile phone 100 to the second position adjacent to the first stylus 53 and then controls the first stylus 53 to touch the touch screen of the mobile phone 100 to enable the mobile phone 100 to perform the touch test and generate the touch test data. In detail, the touch test software in the mobile phone 100 tests the touch function of the mobile phone 100 to acquire the touch test data and then transmits the touch test data to the system 1.

In step 106, the processor 10 receives the touch test data from the mobile phone 100.

In step 107, the processor 10 controls the robotic arm 42 to move the mobile phone 100 to the third position adjacent to the second stylus 66 and then controls the second stylus 66 to apply input presses to the touch screen of the mobile phone 100 to enable the mobile phone 100 to perform the 3D Touch test and generate the 3D Touch test data, wherein the 3D Touch test software in the mobile phone 100 tests the 3D Touch function of the mobile phone 100 to acquire 3D Touch test data and then transmits the 3D Touch test data to the system 1.

In step 108, the processor 10 receives the 3D Touch test data from the mobile phone 100.

In step 109, the processor 10 controls the robotic arm 42 to move the mobile phone 100 to the fourth position under the lighting device 7 and then controls the camera 30 to take the six images of the visible appearance of the mobile phone 100 to generate the appearance data.

In step 110, the processor 10 receives the appearance data from the camera 30.

In step 111, the processor 10 generates an evaluation report for the mobile phone 100 based on the first image, the second image, the touch test data, the 3D Touch test data, and the appearance data. In other exemplary embodiments, the evaluation report is further generated base on test data from the GPS test software, the WiFi test software, the compass test software, the accelerometer test software, the speaker test software, the microphone test software, the vibration motor test software, the distance sensor test software, the Bluetooth test software, and the headset test software.

In the present exemplary embodiment, the method further includes, after the step 102, the step of controlling the electric cylinder 28 to drive the first carrier 25 to continuously move away from the side wall 92 of the housing 9 to enable the first carrier 25 to be separated from the pressing member 221 and then enable the first elastic member 24 to provide the restoring force to drive the shutter 21 to close the opening 9211 of the side wall 92.

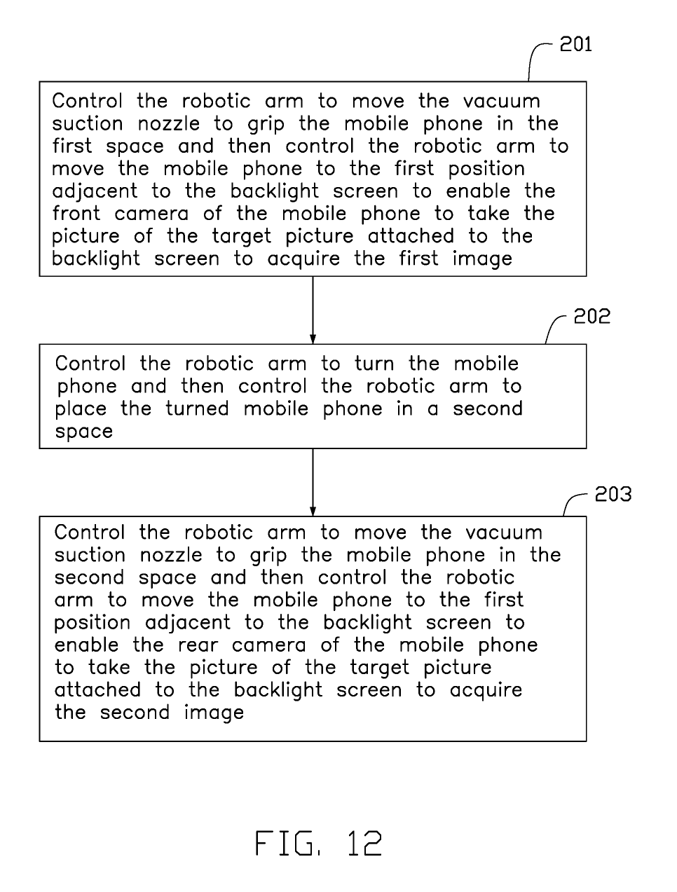

With reference to FIG. 12, in the present exemplary embodiment, a flowchart of the step 103 of FIG. 10 is illustrated.

In step 201, the processor 10 controls the robotic arm 42 to move the vacuum suction nozzle 43 to grip the mobile phone 100 in the first space 254 and then controls the robotic arm 42 to move the mobile phone 100 to the first position adjacent to the backlight screen 32 to enable the front camera of the mobile phone 100 to take the picture of the target picture 321 attached to the backlight screen 32 to acquire the first image.

In step 202, the processor 10 controls the robotic arm 42 to turn the mobile phone 100 and then controls the robotic arm 42 to place the turned mobile phone 100 in the second space 261.

In step 203, the processor 10 controls the robotic arm 42 to move the vacuum suction nozzle 43 to grip the mobile phone 100 in the second space 261 and then controls the robotic arm 42 to move the mobile phone 100 to the first position adjacent to the backlight screen 32 to enable the rear camera of the mobile phone 100 to take the picture of the target picture 321 attached to the backlight screen 32 to acquire the second image.

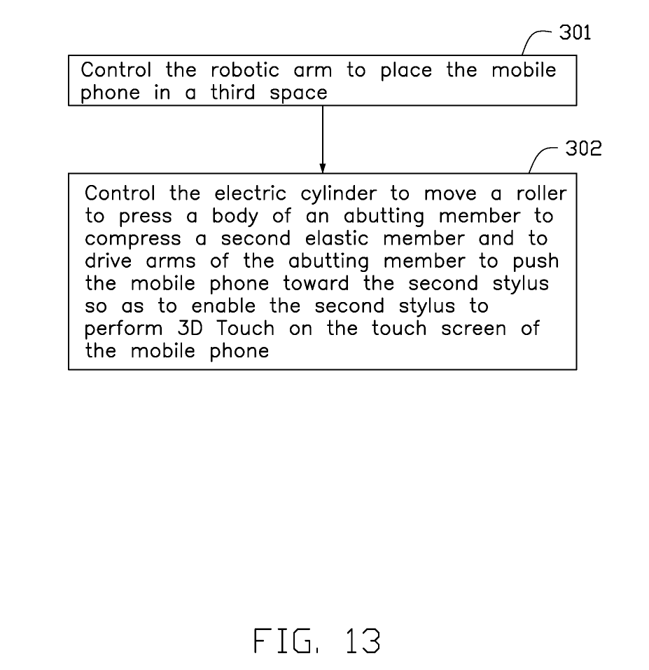

With reference to FIG. 13, in the present exemplary embodiment, a flowchart of the step 107 of FIG. 10 is illustrated.

In step 301, the processor 10 controls the robotic arm 42 to place the mobile phone 100 in the third space 632.

In step 302, the processor 10 controls the electric cylinder 28 to move the roller 62 to press the body 651 of the abutting member 65 to compress the second elastic member 67 and to drive the arms 652 of the abutting member 65 to push the mobile phone 100 toward the second stylus 66 so as to enable the second stylus 66 to perform 3D Touch on the touch screen of the mobile phone 100. In detail, the second elastic member 67 is compressed when the roller 62 begins to move to press the body 651 and the second elastic member 67 provides a restoring force to the body 651 when the roller 62 continuously moves to release the body 651, such that the second stylus 66 performs one 3D Touch on the touch screen of the mobile phone 100 and the second elastic member 67 performs another 3D Touch on the touch screen of the mobile phone 100 when the roller 62 moves back.

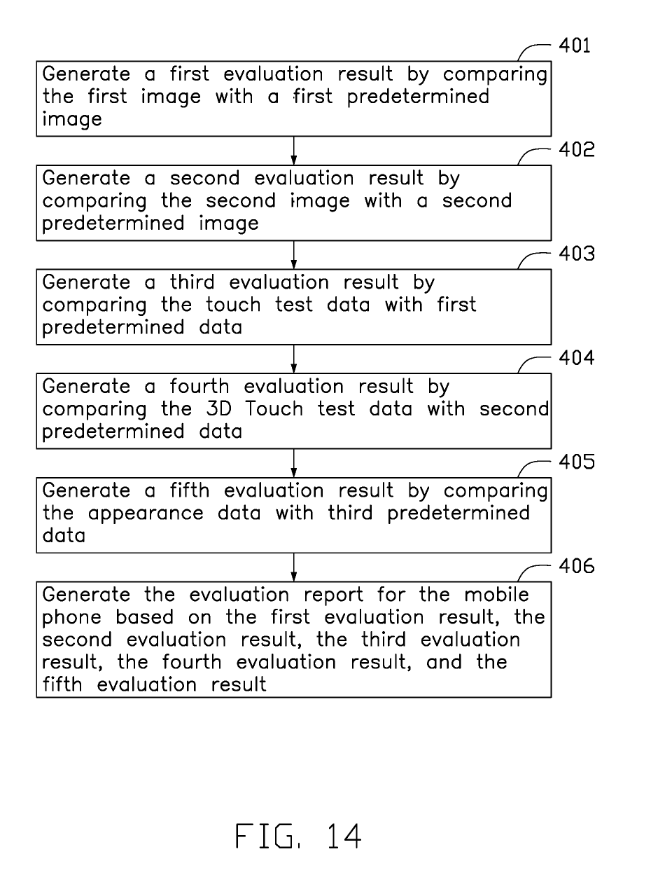

With reference to FIG. 14, in the present exemplary embodiment, a flowchart of the step 111 of FIG. 11 is illustrated.

In step 401, the processor 10 generates a first evaluation result by comparing the first image with a first predetermined image.

In step 402, the processor 10 generates a second evaluation result by comparing the second image with a second predetermined image.

In step 403, the processor 10 generates a third evaluation result by comparing the touch test data with first predetermined data.

In step 404, the processor 10 generates a fourth evaluation result by comparing the 3D Touch test data with second predetermined data.

In step 405, the processor 10 generates a fifth evaluation result by comparing the appearance data with third predetermined data.

In step 406, the processor 10 generates the evaluation report for the mobile phone 100 based on the first evaluation result, the second evaluation result, the third evaluation result, the fourth evaluation result, and the fifth evaluation result.

The exemplary embodiments shown and described above are only examples. Many details are often found in the art such as the other features of a system and method for evaluating mobile phones. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A system for testing a mobile phone running test software so as to evaluate the mobile phone, the system comprising:
a robotic arm assembly having a robotic arm;
a camera test device having a backlight screen and a target picture attached to the backlight screen;
a touch test device having at least one first stylus for touching a touch screen of the mobile phone; and
a 3D Touch test device having at least one second stylus for applying input presses to the touch screen of the mobile phone;
wherein the robotic arm of the robotic arm assembly is used to move the mobile phone to a first position adjacent to the backlight screen to enable a camera of the mobile phone to take a picture of the target picture, is used to move the mobile phone to a second position adjacent to the first stylus to enable the first stylus to touch the touch screen of the mobile phone, and is used to move the mobile phone to a third position adjacent to the second stylus to enable the second stylus to press the touch screen of the mobile phone.

2. The system of claim 1 further comprising:
a housing having a chamber and an opening; and
an access device having:
a shutter configured to selectively open and close the opening of the housing; and
an electric cylinder used to drive the shutter to open the opening of the housing for putting in and taking out the mobile phone;
wherein the robotic arm assembly, the camera test device, the touch test device, the 3D Touch test device, and the access device are received in the chamber of the housing.

3. The system of claim 2, wherein the robotic arm assembly further comprises:
a support base secured to a bottom wall of the housing; and
a vacuum suction nozzle mounted on the robotic arm, and used to grip the mobile phone;
wherein the robotic arm is rotatably mounted on the support base.

4. The system of claim 2, wherein the access device further comprises:
a track secured to the housing adjacent to the opening;
a slider movable along the track;
a support stand moved by the electric cylinder;
a first carrier attached to the support stand; and
a second carrier connected to the first carrier;
wherein the first and second carriers are used to support the mobile phone, the shutter is secured to the slider, and the support stand is moved by the electric cylinder so as to drive the shutter to open the opening of the housing.

5. The system of claim 3, wherein the access device further comprises:
a track secured to the housing adjacent to the opening;
a slider movable along the track;
a support stand moved by the electric cylinder;
a first carrier attached to the support stand; and
a second carrier connected to the first carrier;
wherein the first and second carriers are used to support the mobile phone, the shutter is secured to the slider, and the support stand is moved by the electric cylinder so as to drive the shutter to open the opening of the housing.

6. The system of claim 4, wherein the access device further comprises at least one first elastic member, and the at least one first elastic member has opposite ends, one of which is attached to the housing, and the other of which is attached to the shutter.

7. The system of claim 5, wherein the access device further comprises at least one first elastic member, and the at least one first elastic member has opposite ends, one of which is attached to the housing, and the other of which is attached to the shutter.

8. The system of claim 4, wherein the 3D Touch test device comprises:
a fixed panel secured to the housing;
a third carrier attached to the fixed panel;
an abutting member connected to the fixed panel;
a second elastic member connected between the fixed panel and the abutting member, and the second elastic member having opposite ends, one of which attached to the fixed panel, and the other of which attached to the abutting member;
a space defined between the fixed panel, the third carrier, and the abutting member and used to hold the mobile phone;
a mounting block connected to the support stand; and
a roller rotatably mounted to the mounting block;
wherein the second stylus is mounted on the fixed panel, and the roller is rotated and moved by the electric cylinder to press the abutting member to compress the second elastic member so as to enable the second stylus to press the touch screen of the mobile phone.

9. The system of claim 5, wherein the 3D Touch test device comprises:
a fixed panel secured to the housing;
a third carrier attached to the fixed panel;
an abutting member connected to the fixed panel;
a second elastic member connected between the fixed panel and the abutting member, and the second elastic member having opposite ends, one of which attached to the fixed panel, and the other of which attached to the abutting member;
a space defined between the fixed panel, the third carrier, and the abutting member and used to hold the mobile phone;
a mounting block connected to the support stand; and
a roller rotatably mounted to the mounting block;
wherein the second stylus is mounted on the fixed panel, and the roller is rotated and moved by the electric cylinder to press the abutting member to compress the second elastic member so as to enable the second stylus to press the touch screen of the mobile phone.

10. The system of claim 6, wherein the 3D Touch test device comprises:
a fixed panel secured to the housing;
a third carrier attached to the fixed panel;
an abutting member connected to the fixed panel;
a second elastic member connected between the fixed panel and the abutting member, and the second elastic member having opposite ends, one of which attached to the fixed panel, and the other of which attached to the abutting member;
a space defined between the fixed panel, the third carrier, and the abutting member and used to hold the mobile phone;
a mounting block connected to the support stand; and
a roller rotatably mounted to the mounting block;
wherein the second stylus is mounted on the fixed panel, and the roller is rotated and moved by the electric cylinder to press the abutting member to compress the second elastic member so as to enable the second stylus to press the touch screen of the mobile phone.

11. The system of claim 7, wherein the 3D Touch test device comprises:
a fixed panel secured to the housing;
a third carrier attached to the fixed panel;
an abutting member connected to the fixed panel;
a second elastic member connected between the fixed panel and the abutting member, and the second elastic member having opposite ends, one of which attached to the fixed panel, and the other of which attached to the abutting member;
a space defined between the fixed panel, the third carrier, and the abutting member and used to hold the mobile phone;
a mounting block connected to the support stand; and
a roller rotatably mounted to the mounting block;
wherein the second stylus is mounted on the fixed panel, and the roller is rotated and moved by the electric cylinder to press the abutting member to compress the second elastic member so as to enable the second stylus to press the touch screen of the mobile phone.

12. The system of claim 8, wherein the 3D Touch test device further comprises a support block attached to the fixed panel, and the abutting member is pivotally mounted to the support block.

13. The system of claim 9, wherein the 3D Touch test device further comprises a support block attached to the fixed panel, and the abutting member is pivotally mounted to the support block.

14. The system of claim 10, wherein the 3D Touch test device further comprises a support block attached to the fixed panel, and the abutting member is pivotally mounted to the support block.

15. The system of claim 11, wherein the 3D Touch test device further comprises a support block attached to the fixed panel, and the abutting member is pivotally mounted to the support block.

16. The system of claim 4, further comprising:
a processor;
a communication unit communicating with the mobile phone;
a lighting device; and
at least one camera;
wherein the processor is used to control the shutter to open the opening of the housing for putting the mobile phone on the first carrier, control the robotic arm assembly to move the mobile phone to the first position adjacent to the backlight screen to enable a front camera and a rear camera of the mobile phone to take pictures of the target picture, receive a first image taken by the front camera and a second image taken by the rear camera, control the robotic arm assembly to move the mobile phone to the second position adjacent to the first stylus and then control the first stylus to touch the touch screen of the mobile phone to perform an touch input test, receive touch test data from the touch test, control the robotic arm assembly to move the mobile phone to the third position adjacent to the second stylus and then control the second stylus to press the touch screen of the mobile phone to perform a 3D Touch test, receive 3D Touch test data from the 3D Touch test, control the robotic arm assembly to move the mobile phone to a fourth position under the lighting device and then control the camera to take images of the visible appearance of the mobile phone, receive data as to appearance images of the mobile phone, and generate an evaluation report for the mobile phone based on the first image, the second image, the touch test data, the 3D Touch test data, and the data as to appearance.

17. The system of claim 5, further comprising:
a processor;
a communication unit communicating with the mobile phone;
a lighting device; and
at least one camera;
wherein the processor is used to control the shutter to open the opening of the housing for putting the mobile phone on the first carrier, control the robotic arm assembly to move the mobile phone to the first position adjacent to the backlight screen to enable a front camera and a rear camera of the mobile phone to take pictures of the target picture, receive a first image taken by the front camera and a second image taken by the rear camera, control the robotic arm assembly to move the mobile phone to the second position adjacent to the first stylus and then control the first stylus to touch the touch screen of the mobile phone to perform an touch input test, receive touch test data from the touch test, control the robotic arm assembly to move the mobile phone to the third position adjacent to the second stylus and then control the second stylus to press the touch screen of the mobile phone to perform a 3D Touch test, receive 3D Touch test data from the 3D Touch test, control the robotic arm assembly to move the mobile phone to a fourth position under the lighting device and then control the camera to take images of the visible appearance of the mobile phone, receive data as to appearance images of the mobile phone, and generate an evaluation report for the mobile phone based on the first image, the second image, the touch test data, the 3D Touch test data, and the data as to appearance.

18. The system of claim 6, further comprising:
a processor;
a communication unit communicating with the mobile phone;
a lighting device; and
at least one camera;
wherein the processor is used to control the shutter to open the opening of the housing for putting the mobile phone on the first carrier, control the robotic arm assembly to move the mobile phone to the first position adjacent to the backlight screen to enable a front camera and a rear camera of the mobile phone to take pictures of the target picture, receive a first image taken by the front camera and a second image taken by the rear camera, control the robotic arm assembly to move the mobile phone to the second position adjacent to the first stylus and then control the first stylus to touch the touch screen of the mobile phone to perform an touch input test, receive touch test data from the touch test, control the robotic arm assembly to move the mobile phone to the third position adjacent to the second stylus and then control the second stylus to press the touch screen of the mobile phone to perform a 3D Touch test, receive 3D Touch test data from the 3D Touch test, control the robotic arm assembly to move the mobile phone to a fourth position under the lighting device and then control the camera to take images of the visible appearance of the mobile phone, receive data as to appearance images of the mobile phone, and generate an evaluation report for the mobile phone based on the first image, the second image, the touch test data, the 3D Touch test data, and the data as to appearance.

19. A method for evaluating mobile phones, the method comprising:
controlling a vacuum suction nozzle to grip a mobile phone and then controlling a robotic arm to move the mobile phone to a first position adjacent to a backlight screen to enable a front camera and a rear camera of the mobile phone to take pictures of a target picture attached to the backlight screen;
receiving a first image taken by the front camera and a second image taken by the rear camera;
controlling the robotic arm to move the mobile phone to a second position adjacent to a first stylus and then controlling the first stylus to touch a touch screen of the mobile phone to enable the mobile phone to perform a touch test and generate touch test data;
receiving the touch test data from the mobile phone;
controlling the robotic arm to move the mobile phone to a third position adjacent to a second stylus and then controlling the second stylus to apply input presses to the touch screen of the mobile phone to enable the mobile phone to perform a 3D Touch test and generate 3D Touch test data;
receiving the 3D Touch test data from the mobile phone;
controlling the robotic arm to move the mobile phone to a fourth position under a lighting device and then controlling a camera to take images of the visible appearance of the mobile phone to generate data as to appearance;
receiving the data as to appearance from the camera; and
generating an evaluation report for the mobile phone based on the first image, the second image, the touch test data, the 3D Touch test data, and the appearance data.

20. The method of claim 19, wherein the step of generating the evaluation report for the mobile phone comprises:
generating a first evaluation result by comparing the first image with a first predetermined image;
generating a second evaluation result by comparing the second image with a second predetermined image;
generating a third evaluation result by comparing the touch test data with first predetermined data;
generating a fourth evaluation result by comparing the 3D Touch test data with second predetermined data;
generating a fifth evaluation result by comparing the appearance data with third predetermined data; and
generating the evaluation report for the mobile phone based on the first evaluation result, the second evaluation result, the third evaluation result, the fourth evaluation result, and the fifth evaluation result.
